(19) United States
(12) Patent Application Publication
(10) Pub. No.: US 2013/0174046 A1
(43) Pub. Date: Jul. 4, 2013

(54) SYSTEM AND METHOD OF PROVIDING USER INTERFACE ACCORDING TO LOCATION INFORMATION

(71) Applicant: SAMSUNG ELECTRONICS CO., LTD, Gyeonggi-do (KR)

(72) Inventors: Hun Lim, Gyeonggi-do (KR); Young-jin Kim, Gyeonggi-do (KR); In-ho Park, Seoul (KR)

(73) Assignee: SAMSUNG ELECTRONICS CO., LTD, Gyeonggi-do (KR)

(21) Appl. No.: 13/730,660

(22) Filed: Dec. 28, 2012

(30) Foreign Application Priority Data
Dec. 29, 2011 (KR) 10-2011-0146115

(51) Int. Cl. G06F 3/048

(52) U.S. Cl. CPC G06F 3/048
USPC 715/745

(57) ABSTRACT

According to one embodiment, a system and a method of providing a user interface (UI) according to location information, and a device for providing a UI according to location information includes a usage-history generating unit configured to generate a usage-history of the device based on a location and a movement state of the device, a UI setting unit configured to set the UI according to the usage-history, and a UI changing unit configured to change the UI to be outputted by the device according to a current location and a current movement state of the device based on the setting.

### CROSS-REFERENCE TO RELATED APPLICATION(S) AND CLAIM OF PRIORITY

The present application is related to and claims the benefit of Korean Patent Application No. 10-2011-0146115, filed on Dec. 29, 2011, in the Korean Intellectual Property Office, the disclosure of which is incorporated herein in its entirety by reference.

### TECHNICAL FIELD OF THE INVENTION

The present invention relates to a system and a method of providing a user interface (UI) based on location information, and more particularly, to a system and a method of providing a UI that differs according to movement of a device.

### BACKGROUND OF THE INVENTION

Due to a rapid increase in the use of mobile terminals, they have become a major necessity in people's everyday lives. Now, mobile terminals provide not only voice communication services but also other functions including data services and the like. Also, recently, an environment for supply and use of mobile applications has become well organized, so that the number of mobile applications developed by 3^{rd} party-developers has sharply increased. Accordingly, users may install a large variety of applications in their mobile devices. However, it may be relatively difficult for the users to select an application to be used from among the applications installed in their mobile devices. Also, a user interface (UI) of the mobile terminal may be outputted according to various settings, but it is often difficult for a user to manage these various settings of the UI of the mobile terminal.

### SUMMARY OF THE INVENTION

To address the above-discussed deficiencies of the prior art, it is a primary object to provide a system and a method of providing a user interface (UI) that differs according to a location and a movement state of a device.

The present invention also provides a system and a method for providing a UI, whereby an object and a size of the object to be outputted by a device may be changed based on a movement time and a movement speed of the device.

According to one aspect of the present invention, a device for providing a user interface (UI) according to location information includes a usage-history generating unit configured to generate a usage-history of the device based on a location and a movement state of the device, a UI setting unit configured to set the UI according to the usage-history, and a UI changing unit configured to change the UI to be outputted by the device according to a current location and a current movement state of the device based on the setting.

The device may further include a location checking unit configured to check a location of the device, and a movement state checking unit configured to check a movement state of the device, wherein the usage-history generating unit is configured to generate a usage-history of an application executed in the device according to the checked location and the checked movement state.

The usage-history may include types of the application and information regarding a terminal setting, and the UI setting unit may be configured to set the UI whereby an icon of an application that is executed a predetermined number of times may be outputted by the device.

The movement state may include one or more states regarding a movement or non-movement, a movement time, and a movement speed, which are associated with the device.

The UI setting unit may be configured to set an object and a size of the object outputted by the device according to the movement state of the device.

The UI setting unit may be configured to set the UI in which a size of an object outputted by the device may be adjusted according to the movement speed of the device.

The UI setting unit may be configured to set an object and a size of the object outputted by the device, and the object may include at least one of an icon of an application, a menu, a wall-paper, a font, a ring tone, and a vibration.

According to second aspect of the present invention, a method of providing a user interface (UI) according to location information includes the operations of generating a usage-history of the device based on a location and a movement state of the device, setting the UI according to the usage-history, and changing the UI to be outputted by the device according to a current location and a current movement state of the device based on the setting.

The method may further include the operations of checking a location of the device, and checking a movement state of the device, wherein the operation of generating the usage-history may includes an operation of generating a usage-history of an application executed in the device according to the checked location and the checked movement state.

The usage-history may include types of the application and information regarding a terminal setting, and the operation of setting the UI may include an operation of setting the UI whereby an icon of an application that is executed a predetermined number of times may be outputted by the device.

The movement state may include one or more states regarding a movement or non-movement, a movement time, and a movement speed, which are associated with the device.

The operation of setting the UI may include an operation of setting an object and a size of the object outputted by the device according to the movement state of the device.

The operation of setting the UI may include an operation of setting the UI in which a size of an object outputted by the device may be adjusted according to the movement speed of the device.

The operation of setting the UI may include an operation of setting an object and a size of the object output by the device, and the object may include at least one of an icon of an application, a menu, a wall-paper, a font, a ring tone, and a vibration.

According to third aspect of the present invention, a method of providing a user interface (UI) according to location information that includes the operations of storing a usage-history of the device based on a location and a movement state of the device, setting the UI according to the usage-history, selecting the UI to be outputted by the device according to a current location and a current movement state of the device, and outputting the selected UI.

According to fourth aspect of the present invention, a non-transitory computer-readable recording medium having recorded thereon a program for executing the method according to the second aspect of the present invention by using a computer.

According to fifth aspect of the present invention, a non-transitory computer-readable recording medium having recorded thereon a program for executing the method according to the third aspect of the present invention by using a computer.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates and example configuration of a device that provides a user interface (UI) according to an embodiment of the present invention;

FIG. 2 illustrates an example usage-history table according to an embodiment of the present invention;

FIG. 3 illustrates an example UI setting table according to an embodiment of the present invention;

FIG. 4 illustrates an example UI that is changed and outputted according to a location and a movement state of the device according to an embodiment of the present invention;

FIG. 5 illustrates an example method for providing a UI according to an embodiment of the present invention; and

FIG. 6 illustrates an example method of changing and providing a UI according to another embodiment of the present invention.

### DETAILED DESCRIPTION OF THE INVENTION

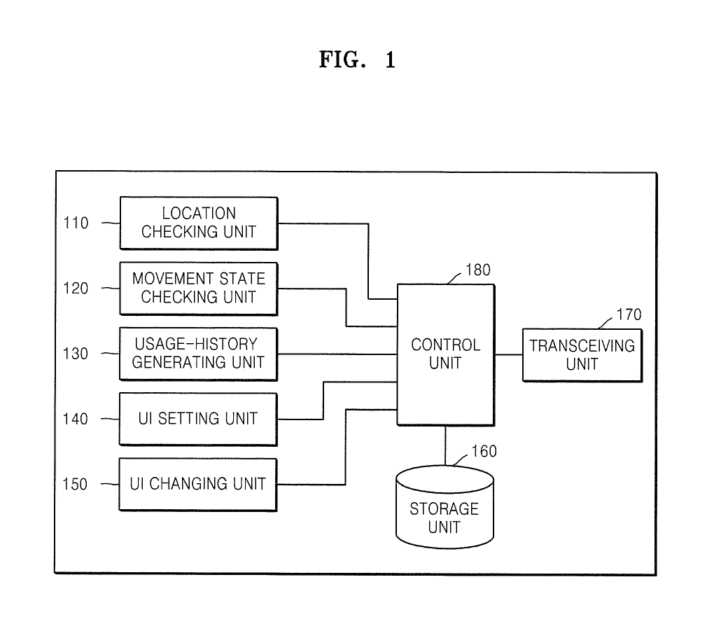

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged user interface devices. Hereinafter, the present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art. In the following description, well-known functions or constructions are not described in detail so as not to obscure the invention with unnecessary detail. Also, throughout the specification, like reference numerals in the drawings denote like elements.

Throughout the specification, it will also be understood that when an element is referred to as being “connected to” another element, it can be directly connected to the other element, or electrically connected to the other element while intervening elements may also be present. Also, when a part “includes” or “comprises” an element, unless there is a particular description contrary thereto, the part can further include other elements in addition to the element.

Expressions such as “at least one of,” when preceding a list of elements, modify the entire list of elements and do not modify the individual elements of the list.

FIG. 1 illustrates an example configuration of a device that provides a user interface (UI) according to an embodiment of the present invention.

As illustrated in FIG. 1, the device that provides the UI may include a location checking unit 110, a movement state checking unit 120, a usage-history generating unit 130, a UI setting unit 140, a UI changing unit 150, a storage unit 160, a transceiving unit 170, and a control unit 180.

The location checking unit 110 checks a location of the device. The location checking unit 110 may check location information of the device by using a global positioning system (GPS) sensor and a wireless transceiving module that are included in the device. For example, the location information may include GPS coordinate values, an identifier (ID) of a base station, a service set identifier (SSID) of an access point (AP), and a network address. In certain embodiments, the location information may include any suitable type of information.

The movement state checking unit 120 checks a movement state of the device. The movement state checking unit 120 may check the movement state of the device by using the GPS sensor, an acceleration sensor, and a magnetic field sensor included in the device. Also, the movement state may include states regarding a movement or non-movement, a movement time, and a movement speed, which are associated with the device. For example, the movement state checking unit 120 may check a time period in which the device is moved at a speed equal to or greater than a predetermined speed and may check an average movement speed of the device.

The usage-history generating unit 130 generates a usage-history of the device based on the location and the movement state of the device. The usage-history generating unit 130 may generate a usage-history with respect to applications executed in the device, based on the location and the movement state of the device. The usage-history generating unit 130 may allow the usage-history to include information regarding applications that are executed a predetermined number of times in a predetermined location and movement state. For example, in a case where the device is connected to a wireless access point (AP) whose SSID is ‘MyHome’ executes a ‘TV program guide’ in its stopped state, the usage-history generating unit 130 may record the ‘TV program guide’, which corresponds to ‘MyHome’ and ‘stopped state’ of the device, to a usage-history table.

Also, the use-history generating unit 130 may record a terminal state value of the device to the usage-history table based on the location and the movement state of the device. For example, in a case where the device connected to the wireless AP whose SSID is ‘MyHome’ is in the stopped state, when a ring tone of the device is in an ‘ON state’ and a wireless-fidelity (WI-FI) function of the device is in an ‘ON state’, the usage-history generating unit 130 may record ‘ring tone: ON’ and ‘WI-FI: ON’ as the terminal state value that corresponds to ‘MyHome’ and ‘stopped state’ of the device.

Also, the usage-history generating unit 130 may record an application and a terminal state value according to the location and the movement state of the device to the usage-history table based on a user input. In this case, the user may select a UI configuration value from among the terminal state value and the application that is installed in the device.

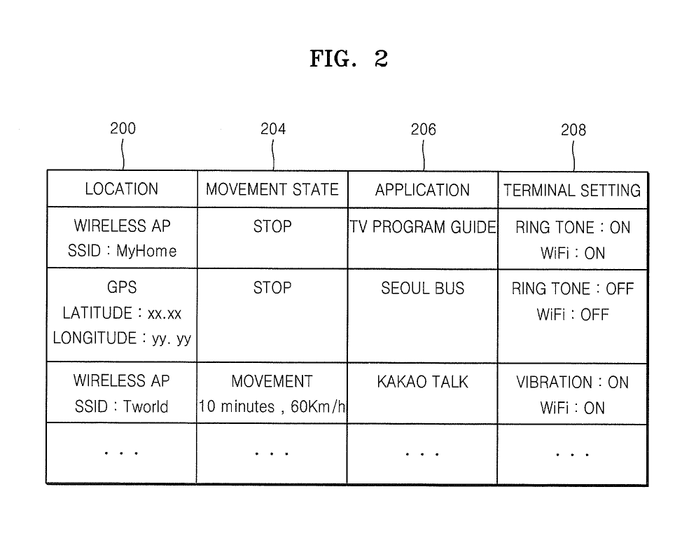

The usage-history generated by the use-history generating unit 130 will be described in detail with reference to FIG. 2.

The UI setting unit 140 sets a UI to be outputted by the device based on the generated usage-history. The UI setting unit 140 may set the UI to be outputted by the device according to the location and the movement state of the device. More specifically, the UI setting unit 140 may set an object and a size of the object to be outputted by the device, and the object to be outputted by the device may include at least one of an application icon, a menu, a wall-paper, a font, a ring tone, and a vibration. Also, the UI setting unit 140 may set a type of an object to be outputted by the device. In this case, the object that is predefined according to the location and the movement state of the device may be outputted by the device.

For example, in a case where the device connected to the wireless AP whose SSID is ‘MyHome’ is in the stopped state, the UI setting unit 140 may set the UI so that icons of applications ‘A’, ‘B’, and ‘C’ may be outputted to a size ‘3’ screen, and a font to be displayed in the device may be a size ‘10’ ‘arial’ font-type. Also, in a case where the device connected to the wireless AP whose SSID is ‘MyHome’ is in the stopped state, the UI setting unit 140 may set the UI so that an image ‘homeback.jpg’ may be outputted as a wall-paper, and a ring tone ‘bird’ at a volume ‘5’ may be output.

In a case where the device is moved, the UI setting unit 140 may set the UI so that a size of an object to be outputted by the device may be equal to or greater than a predefined value. For example, when the device is in a stopped state, the UI setting unit 140 may set the UI so that an icon of an application may be displayed having a size ‘3’, and when the device is moved, the UI setting unit 140 may set the UI so that the icon of the application may be displayed having a size ‘10’.

Also, the UI setting unit 140 may adjust a size of an object to be displayed on the device, according to a movement speed of the device. For example, when the device is moved at a speed of 5 to 10 m/s, the UI setting unit 140 may set the UI so that an icon of an application may be displayed having a size ‘7’, and when the device is moved at a speed of 10 to 15 m/s, the UI setting unit 140 may set the UI so that the icon of the application may be displayed having a size ‘10’.

Also, the UI setting unit 140 may allow an icon of an application, which is executed a predetermined number of times, to be displayed on a screen of the device By doing so, the icon of the application that is frequently used by a user may be displayed on the screen according to the location and the movement state of the device.

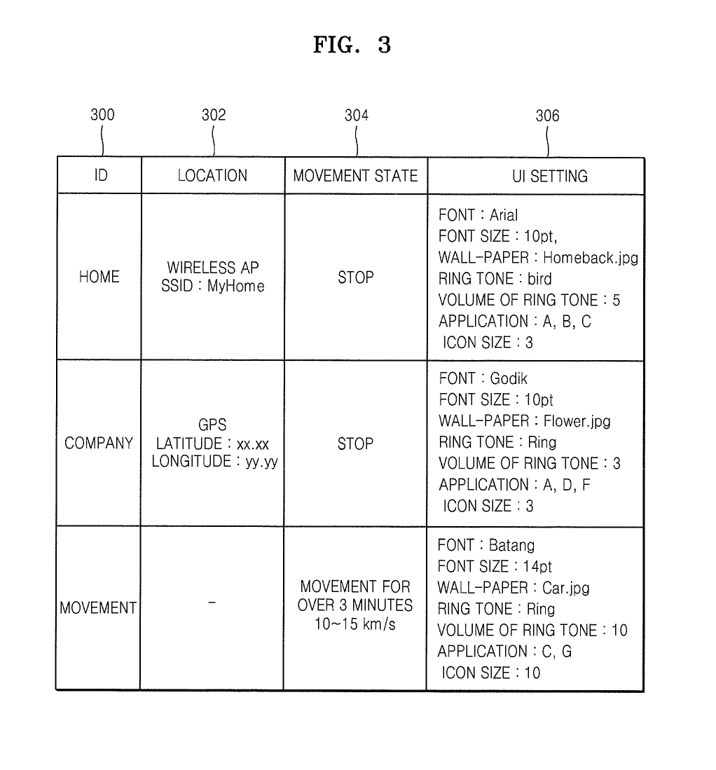

A UI setting table generated by the UI setting unit 140 will be described in detail with reference to FIG. 3.

The UI changing unit 150 changes the UI to be output by the device, according to a current location and a current movement state of the device. The UI changing unit 150 may check a UI setting value in the UI setting table, wherein the UI setting value corresponds to the current location and the current movement state of the device, and then may change the UI to be output by the device, according to the checked UI setting value. For example, the UI changing unit 150 may change at least one of an icon of an application to be output by the device, a menu, a wall-paper, a font, a ring tone, and a vibration but the one or more embodiments of the present invention are not limited thereto.

The storage unit 160 stores various types of information so as to allow the device to change and output the UI according to the location and the movement state of the device. The storage unit 160 may store the usage-history table and the UI setting table but types of information are not limited thereto.

The transceiving unit 170 exchanges various types of information with an external device so as to allow the device to change and output the UI according to the location and the movement state of the device. For example, the transceiving unit 170 may receive GPS coordinate values, an ID of a base station, an SSID of an AP, and a network address but the types of information are not limited thereto.

The control unit 180 controls an overall operation of the device, and controls the location checking unit 110, the movement state checking unit 120, the usage-history generating unit 130, the UI setting unit 140, the UI changing unit 150, the storage unit 160, and the transceiving unit 170 so as to allow the device to change and output the UI according to the location and the movement state of the device.

Hereinafter, the usage-history table will be described with reference to FIG. 2.

FIG. 2 is a diagram illustrating an example of the usage-history table, according to an embodiment of the present invention.

As illustrated in FIG. 2, the use-history table according to the present invention includes a location field 200, a movement state field 202, an application field 204, and a terminal setting field 206.

A location value of a device is recorded to the location field 200. At least one of GPS coordinate values, an ID of a base station, an SSID of an AP, and a network address may be recorded to the location field 200. For example, ‘MyHome’ that is an SSID value of a wireless AP connected to the device may be recorded to the location field 200, or ‘latitude: xx.xx’ and ‘longitude: yy.yy’ that are the GPS coordinate values of the device may be recorded to the location field 200.

The movement state field 202 has a value regarding a movement state of the device recorded thereto. The movement state may include states regarding a movement or non-movement, a movement time, and a movement speed, which are related to the device. For example, values regarding the movement or non-movement, the movement time, and the movement speed may be recorded to the movement state field 202.

The application field 204 has a title of an application recorded thereto, wherein the application corresponds to a location and the movement state of the device. That is, a title of an application that is executed in a predetermined location and movement state may be recorded to the application field 204, and a title of an application that is executed a predetermined number of times may be recorded to the application field 204. Also, a title of an application selected by a user input may be recorded to the application field 204.

The terminal setting field 26 has a terminal setting value recorded thereto, wherein the terminal setting value corresponds to the location and the movement state of the device. The terminal setting field 26 may have a terminal setting value recorded thereto in a predetermined location and a predetermined movement state. For example, a value regarding whether a ring tone is activated or a WI-FI function is activated may be recorded to the terminal setting field 26 but the types of information are not limited thereto.

Hereinafter, the UI setting table will be described with reference to FIG. 3.

FIG. 3 is a diagram illustrating an example of the UI setting table, according to an embodiment of the present invention.

As illustrated in FIG. 3, the UI setting table according to the present embodiment includes an ID field 300, a location field 302, a movement state field 304, and a UI setting field 306.

The ID field 300 has a recorded ID value associated with a UI setting. For example, a value associated with a predetermined location such as ‘home’ may be recorded to the ID field 300 as the ID value. Also, a value, e.g., ‘movement 1’, which indicates movement of the device may be recorded to the ID field 300 as the ID value.

The location field 302 has a recorded location value of the device. The location field 302 may have at least one of GPS coordinate values, an ID of a base station, an SSID of an AP, and a network address.

The movement state field 304 has a recorded value associated with a movement state of the device. The movement state may include states associated with a movement or non-movement, a movement time, and a movement speed, which are associated with the device. Values associated with the movement or non-movement, the movement time, and the movement speed may be recorded in the movement state field 304. For example, the values such as ‘movement for more than 3 minutes’ and ‘10 to 15 km/s’ that are associated with a movement time and an average movement speed may be recorded to the movement state field 304.

The UI setting field 306 has a recorded UI setting value, wherein the UI setting value corresponds to the location and the movement state of the device. The UI setting field 306 may have recorded values, wherein the values are associated with an object and a size of the object to be outputted by the device. For example, the UI setting field 306 may have recorded values, wherein the values are associated with a font, a size of the font, a wall-paper, a ring tone, a volume of the ring tone, a title of an application, and/or a size of an icon of the application.

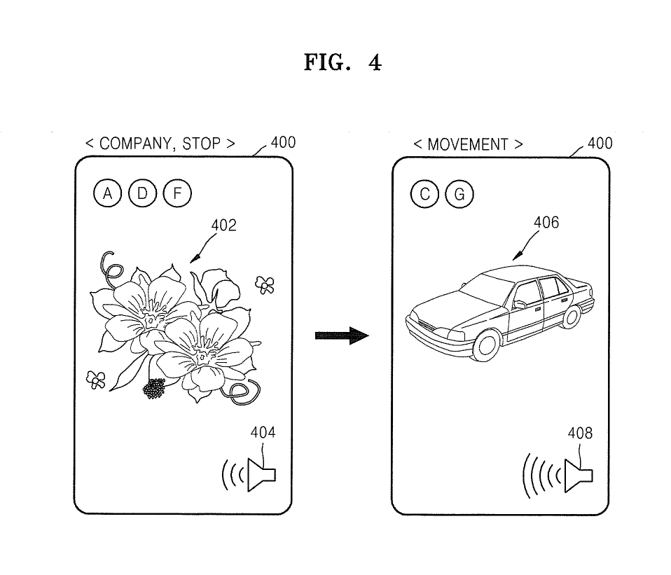

Hereinafter, the UI that is changed and outputted according to the location and the movement state of the device will be described with reference to FIG. 4.

FIG. 4 illustrates an example of the UI that is changed and outputted according to the location and the movement state of the device according to an embodiment of the present invention.

As illustrated in FIG. 4, when the device is in a stopped state in a company, icons having a size ‘3’ of applications ‘A’, ‘D’, and ‘F’ may be displayed on a screen 400 of the device, and a ‘flower.jpg’ may be displayed on the screen 400 as a wall-paper 402. Also, a ring tone icon 404 whose volume value is set as ‘3’ may be displayed on the screen 400.

In a case where the device is moved for more than 3 minutes at a speed of 10 to 15 km/s, the UI may be changed and outputted by the device. For example, icons having a size ‘10’ of applications ‘C’ and ‘G’ may be displayed on the screen 400 of the device, and a ‘car.jpg’ may be displayed on the screen 400 as a wall-paper 406. Also, a ring tone icon 408 whose volume value is set as ‘10’ may be displayed on the screen 400.

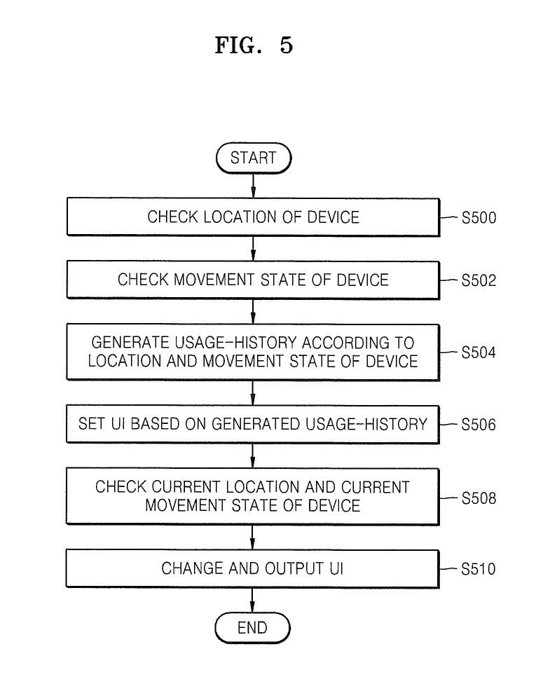

Hereinafter, a method of providing a UI will be described with reference to FIG. 5.

FIG. 5 illustrates an example method of providing a UI according to an embodiment of the present invention.

In operation S500, a device checks its location. In operation S500, the device may check location information of the device by using a GPS sensor and a wireless transceiving module that are included in the device. For example, the location information may include GPS coordinate values, an ID of a base station, an SSID of an AP, and a network address. In other embodiments, any type of location information may be used.

In operation S502, the device checks a movement state of the device. In operation S502, the device may check the movement state of the device, by using the GPS sensor, an acceleration sensor, and/or a magnetic field sensor that are included in the device. Also, the movement state may include states regarding a movement or non-movement, a movement time, and a movement speed, which are associated with the device. For example, the device may check a time period in which the device is moved at a speed equal to or greater than a predetermined speed and may check an average movement speed of the device.

In operation S504, the device generates a usage-history of the device based on the location and the movement state of the device. The device may generate a usage-history with respect to applications executed in the device based on the location and the movement state of the device. The device may include information regarding applications that are executed a predetermined number of times in a predetermined location and movement state. For example, in a case where the device connected to a wireless AP whose SSID is ‘MyHome’ executes a ‘TV program guide’ in its stopped state, the device may record the ‘TV program guide’, which corresponds to ‘MyHome’ and ‘stopped state’ of the device, to a usage-history table.

Also, in operation S504, the device may record a terminal state value of the device to the use-history table based on the location and the movement state of the device. For example, in a case where the device connected to the wireless AP whose SSID is ‘MyHome’ is in the stopped state, when a ring tone of the device is in an ‘ON state’ and a wireless-fidelity (WI-FI) function of the device is in an ‘ON state’, the device may record ‘ring tone: ON’and ‘WI-FI: ON’ as the terminal state value that corresponds to ‘MyHome’ and ‘stopped state’ of the device.

Also, in operation S504, the device may record an application and a terminal state value according to the location and the movement state of the device to the usage-history table based on a user input. In this case, the user may select a UI configuration value from among the terminal state value and the application that is installed in the device.

In operation S506, the device sets a UI to be outputted by the device based on the usage-history. The device may set the UI to be outputted by the device, according to the location and the movement state of the device. More specifically, the device may set an object and a size of the object to be outputted by the device, and the object to be outputted by the device may include at least one of an application icon, a menu, a wall-paper, a font, a ring tone, and/or a vibration. Also, the device may set a type of an object to be outputted by the device. In this case, the object that is predefined according to the location and the movement state of the device may be outputted by the device.

For example, in a case where the device connected to the wireless AP whose SSID is ‘MyHome’ is in the stopped state, the device may set the UI so that icons of certain applications may be outputted to a screen having a specified size, and certain fonts to be displayed in the device, such as an ‘arial’ font-type having a size ‘10’. Also, in a case where the device connected to the wireless AP whose SSID is ‘MyHome’ is in the stopped state, the device may set the UI so that a specified image file may be outputted as a wall-paper, along with certain ring tones.

In operation S506, in a case where the device is moved, the device may set the UI so that a size of an object to be outputted by the device may be equal to or greater than a predefined value. For example, when the device is in the stopped state, the device may set the UI so that an icon of an application may be displayed having a specified size, and when the device is moved, the device may set the UI so that the icon of the application may be displayed having a different size.

Also, in operation S506, the device may adjust a size of an object to be displayed on the device according to a movement speed of the device. For example, when the device is moved at a speed of 5 to 10 m/s, the device may set the UI so that an icon of an application may be displayed having a specified size, and when the device is moved at a speed of 10 to 15 m/s, the device may set the UI so that the icon of the application may be displayed having a different size.

Also, in operation S506, the device may display an icon of an application, which is executed a predetermined number of times, on a screen of the device. By doing so, the icon of the application that is frequently used by a user may be displayed on the screen according to the location and the movement state of the device.

In operation S508, the device checks a current location and a current movement state of the device. The device may check the current location and the current movement state of the device using the GPS sensor, the wireless transceiving module, the acceleration sensor, and/or the magnetic field sensor that are included in the device.

In operation S510, the device changes and outputs the UI that corresponds to the current location and the current movement state. The device may check a UI setting value in a UI setting table, wherein the UI setting value corresponds to the current location and the current movement state of the device, and then may change the UI to be outputted by the device, according to the checked UI setting value. For example, the device may change at least one of an icon of an application to be outputted by the device, a menu, a wall-paper, a font, a ring tone, and/or a vibration. Other embodiments the device may change other features not listed herein.

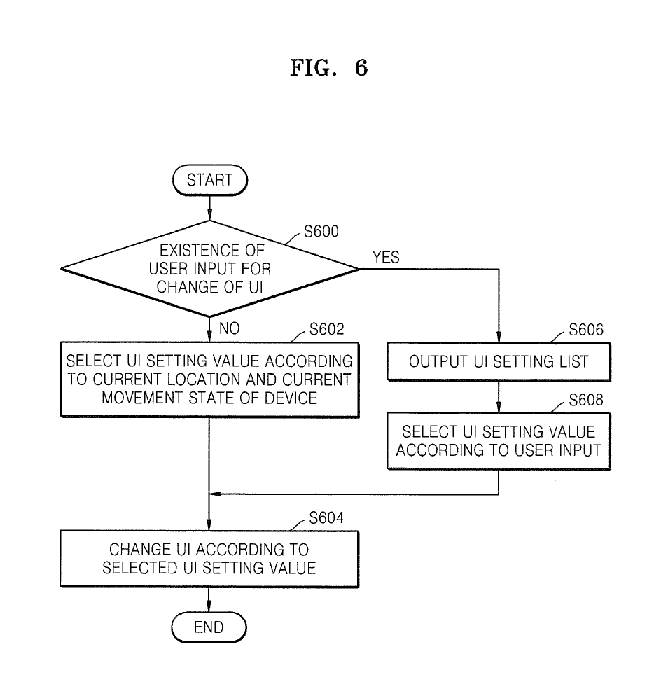

Hereinafter, a method of changing and providing a UI will be described with reference to FIG. 6.

FIG. 6 illustrates an example method of changing and providing a UI according to another embodiment of the present invention.

In operation S600, a device determines whether user input exists for a changing the UI.

As a result of the determination (operation S600), if the user input exists for changing the UI, the device may check location information of the device by using a GPS sensor and a wireless transceiving module that are included in the device, and may check a movement state of the device by using the GPS sensor, an acceleration sensor, and/or a magnetic field sensor that are included in the device in operation S602. Also, the device may select a UI setting value in a UI setting table, wherein the UI setting value corresponds to a value of the checked position and movement state of the device.

Afterward, in operation S604, the device may change the UI to be outputted by the device according to the selected UI setting value.

Also, as a result of the determination (operation S600), if the user input exists for changing the UI, the device may output a UI setting list on a screen of the device in operation S606. The UI setting list may be generated from a UI setting table stored in the storage unit 160 and then may be outputted.

Afterward, in operation S608, the device selects a UI setting value based on the user input. In operation S604, the device changes and outputs the UI on the screen of the device according to the selected UI setting value.

According to the one or more embodiments of the present invention, the provided UI may differ according to a location and a movement state of the device.

Also, according to the one or more embodiments of the present invention, an object and a size of the object to be output by the device may be changed based on a movement time and a movement speed of the device.

The one or more embodiments of the present invention may be written as computer programs in a recording medium, e.g., a program module to be executed in computers, which include computer-readable commands. The computer storage medium may include any usable medium that may be accessed by computers, volatile and non-volatile media, and detachable and non-detachable media. Also, the computer storage medium may include a computer storage medium and a communication medium. The computer storage medium includes all of volatile and non-volatile media, and detachable and non-detachable media which are designed to store information including computer readable commands, data structures, program modules or other data. The communication medium includes computer-readable commands, a data structure, a program module, and other transmission mechanisms, and includes other information transmission media.

The present invention may, however, be embodied in many different forms and should not be construed as being limited to the embodiments set forth herein; rather, these embodiments are provided so that this disclosure will be thorough and complete, and will fully convey the inventive concept to those of ordinary skill in the art.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A device configured to provide a user interface (UI) according to location information, the device comprising:
a usage-history generating unit configured to generate a usage-history of the device based on a location and a movement state of the device;
a UI setting unit configured to set the UI according to the usage-history; and
a UI changing unit configured to change the UI to be outputted by the device according to a current location and a current movement state of the device based on the setting.

2. The device of claim 1, further comprising:
a location checking unit configured to check a location of the device; and
a movement state checking unit configured to check a movement state of the device,
wherein the usage-history generating unit is configured to generate a usage-history of an application executed in the device, according to the checked location and the checked movement state.

3. The device of claim 1, wherein the usage-history comprises types of the application and information regarding a terminal setting, and
the UI setting unit is configured to set the UI whereby an icon of an application that is executed a predetermined number of times is outputted by the device.

4. The device of claim 1, wherein the movement state comprises one or more states regarding a movement or non-movement, a movement time, and a movement speed, which are associated to the device.

5. The device of claim 4, wherein the UI setting unit is configured to set an object and a size of the object outputted by the device according to the movement state of the device.

6. The device of claim 4, wherein the UI setting unit is configured to set the UI in which a size of an object outputted by the device is configured to be adjusted according to the movement speed of the device.

7. The device of claim 1, wherein the UI setting unit is configured to set an object and a size of the object outputted by the device, and
the object comprises at least one of an icon of an application, a menu, a wall-paper, a font, a ring tone, and a vibration

8. A method of providing a user interface (UI) according to location information, the method comprising:
generating a usage-history of the device based on a location and a movement state of the device;
setting the UI according to the usage-history; and
changing the UI to be outputted by the device according to a current location and a current movement state of the device based on the setting.

9. The method of claim 8, further comprising:
checking a location of the device; and
checking a movement state of the device,
wherein the generating of the usage-history comprises generating a usage-history of an application executed in the device according to the checked location and the checked movement state.

10. The method of claim 9, wherein the usage-history comprises types of the application and information regarding a terminal setting, and
the setting of the UI comprises setting the UI in which an icon of an application that is executed a predetermined number of times is outputted by the device.

11. The method of claim 8, wherein the movement state comprises one or more states regarding a movement or non-movement, a movement time, and a movement speed, which are associated with the device.

12. The method of claim 11, wherein the setting of the UI comprises setting an object and a size of the object outputted by the device according to the movement state of the device.

13. The method of claim 11, wherein the setting of the UI comprises setting the UI in which a size of an object outputted by the device is adjusted according to the movement speed of the device.

14. The method of claim 8, wherein the setting of the UI comprises setting an object and a size of the object outputted by the device, and
the object comprises at least one of an icon of an application, a menu, a wall-paper, a font, a ring tone, and a vibration.

15. A method of providing a user interface (UI) according to location information, the method comprising:
storing a usage-history of the device based on a location and a movement state of the device;
setting the UI according to the usage-history;
selecting the UI to be outputted by the device according to a current location and a current movement state of the device; and
outputting the selected UI.

16. A non-transitory computer-readable recording medium having recorded thereon a program for executing the method of claim 8, by using a computer.

17. A non-transitory computer-readable recording medium having recorded thereon a program for executing the method of claim 15, by using a computer.

18. The method of claim 15, wherein the usage-history comprises types of the application and information regarding a terminal setting, and
the setting of the UI comprises setting the UI in which an icon of an application that is executed a predetermined number of times is outputted by the device.

19. The method of claim 15, wherein the setting of the UI comprises setting an object and a size of the object outputted by the device according to the movement state of the device.

20. The method of claim 15, wherein the setting of the UI comprises setting the UI in which a size of an object outputted by the device is adjusted according to the movement speed of the device.
